(19) United States
(12) Patent Application Publication
(10) Pub. No.: US 2025/0342388 A1
(43) Pub. Date: Nov. 6, 2025

(54) REMOTE DESKTOP SESSION RECORDING AND AUDITING USING GENERATIVE ARTIFICIAL INTELLIGENCE

(71) Applicant: Ominissa, LLC, Mountain View, CA (US)

(72) Inventor: Lin LV, Beijing (CN)

(21) Appl. No.: 18/652,744

(22) Filed: May 1, 2024

(51) Int. Cl. G06N 20/00; G06F 9/451

(52) U.S. Cl. CPC G06N 20/00; G06F 9/452

(57) ABSTRACT

A method of auditing user actions performed in remote desktop (RD) sessions, includes the steps of: acquiring a first video file that visually captures a plurality of first user actions that were performed in a first RD session by a remote device hosting the first RD session in response to instructions from a client device of the first RD session; generating a first text file describing the first user actions from the first video file, by using a generative artificial intelligence (AI) model that has been trained to generate text descriptions of user actions from video data capturing user actions in RD sessions; searching the first text file for keywords or phrases that have been identified as being associated with prohibited or suspicious actions; and in response to detecting one of the keywords or phrases in the first text file, terminating the first RD session.

### BACKGROUND

Many organizations rely on remote desktop (RD) computer systems to provide lean, flexible computing environments for users such as employees. An RD is a software feature or program that allows an end user to access and control a desktop running on a remote computing device such as a server, from another location over a network. To connect to an RD, a user initiates an RD session, which is a two-way link between a client device such as a user's personal computer, and a remote device hosting an RD, wherein the user's actions performed at the client device are transmitted to the remote device to update software of the RD, and a display of the RD, e.g., an image of a graphical user interface (GUI), is transmitted to the client device. The user actions include inputs such as the user clicking a mouse or typing on a keyboard, along with resulting behaviors such as an application being installed in an RD computing environment or a web browser in the RD environment navigating to a website.

For security purposes, some organizations such as banks record RD sessions to monitor such user actions therein. Later, the organizations review the recordings to detect malicious behaviors in the RD environments, such as accessing prohibited websites and installing or using prohibited applications. Despite having access to such recordings, organizations often fail to detect malicious behaviors fast enough to respond effectively. Indeed, auditing such recordings for large organizations with potentially tens of thousands of employees, each accessing their own RD session, is time-consuming for administrators. Additionally, as the amount of user behavior to monitor increases, the amount of storage required for recordings also increases, thus increasing storage costs for organizations. A solution is desired to improve the above shortcomings of recording and auditing RD sessions.

### SUMMARY

One or more embodiments provide a method of auditing user actions performed in RD sessions. The method includes the steps of: acquiring a first video file that visually captures a plurality of first user actions that were performed in a first RD session by a remote device hosting the first RD session in response to instructions from a client device of the first RD session; generating a first text file describing the first user actions from the first video file, by using a generative artificial intelligence (AI) model that has been trained to generate text descriptions of user actions from video data capturing user actions in RD sessions; searching the first text file for keywords or phrases that have been identified as being associated with prohibited or suspicious actions; and in response to detecting one of the keywords or phrases in the first text file, terminating the first RD session.

Further embodiments include a non-transitory computer-readable storage medium comprising instructions that cause a computer system to carry out the above method, as well as a computer configured to carry out the above method.

### BRIEF DESCRIPTION OF THE DRAWINGS

FIG. 1 is a block diagram of a computer system in which embodiments may be implemented.

FIG. 2 is a block diagram of an RD session of the computer system.

FIG. 3 is a flow diagram of a method performed by a connection device of the computer system to train a generative AI model, according to some embodiments.

FIG. 4 is a flow diagram of a method performed by the connection device and a client device and remote device of the computer system to start and monitor an RD session, according to some embodiments.

FIG. 5 is a flow diagram of a method performed by the connection device to audit recordings of RD sessions, according to some embodiments.

### DETAILED DESCRIPTION

Techniques are described for auditing user actions performed in RD sessions. A remote computing device hosting computing environments of the RD sessions records the RD sessions to capture user actions thereof. According to some embodiments, the remote device transmits video files of such recordings to another device, referred to herein as a “connection device,” for auditing. Such video files may capture user behavior in intervals of time of a predetermined length, e.g., each video file corresponding to the last five minutes of user behavior. Then, to audit such video files, generative AI is utilized, generative AI being AI that is capable of generating data such as text, images, and videos, e.g., in response to prompts.

A generative AI model is trained to generate text descriptions of user behaviors captured by such video files (in words). The connection device then parses those text descriptions for keywords or phrases associated with potentially malicious behaviors. Some of such behaviors, referred to herein as “prohibited” behaviors, violate policies of an organization such as by accessing websites restricted by the organization. Others of such behaviors, referred to herein as “suspicious” behaviors, do not necessarily violate such policies but have been determined to warrant alerting of or warning to at least one of an administrator and a user of an RD session because such behaviors often indicate malicious activity.

Embodiments described herein enable fast detection of malicious behaviors, which allows for fast response. For example, if the connection device detects a prohibited behavior from the text description of a video file, the connection device automatically terminates the corresponding RD session to stop the prohibited behavior from continuing. Furthermore, if a suspicious behavior is detected, the administrator is alerted to review the corresponding video file, the administrator thus only manually auditing videos with suspicious behaviors therein instead of wasting time auditing videos with no such behaviors. Accordingly, malicious behaviors may be detected and responded to quickly either automatically or in response to manual auditing by administrators. Furthermore, video files that have been determined not to capture any prohibited or suspicious behaviors are automatically deleted, thus reducing storage costs associated with monitoring users of the RD sessions. These and further aspects of the invention are discussed below with respect to the drawings.

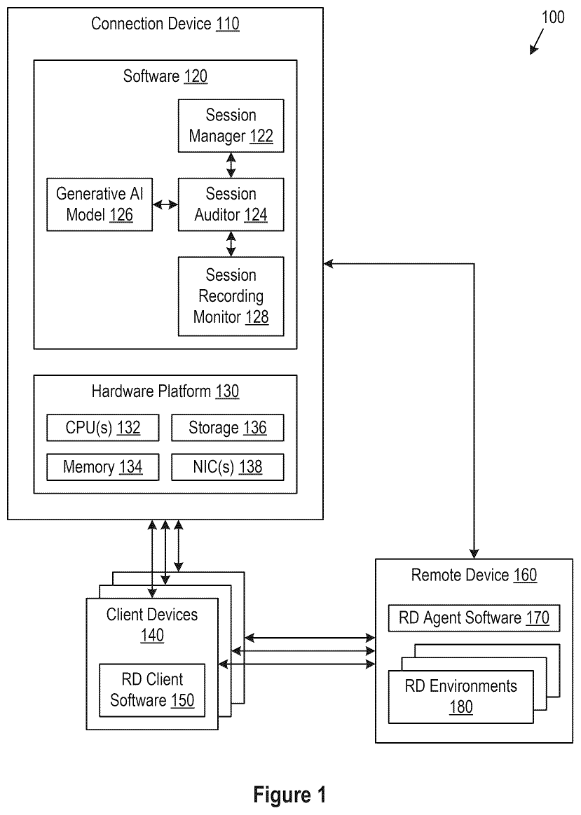

FIG. 1 is a block diagram of a computer system 100 in which embodiments may be implemented. Computer system 100 includes a plurality of client devices 140, a remote device 160, and a connection device 110. Remote device 160 hosts a plurality of RD environments 180, each of RD environments 180 being a computing environment with an interface such as a GUI through which a user performs actions on remote device 160 such as launching applications thereon. Each of client devices 140 accesses one or more of RD environments 180 via RD sessions between client device 140 and remote device 160. Such RD sessions are orchestrated and monitored by connection device 110.

Connection device 110 is a computer, such a server in a private data center controlled by an organization. Connection device 110 is constructed on a hardware platform 130 such as an x86 architecture platform. Hardware platform 130 includes conventional components of a computing device, such as one or more central processing units (CPUs) 132, memory 134 such as random-access memory (RAM), local storage 136 such as one or more magnetic drives or solid-state drives (SSDs), and one or more network interface controllers (NICs) 138. CPU(s) 132 are configured to execute instructions such as executable instructions that perform one or more operations described herein, which may be stored in memory 134. NIC(s) 138 enable connection device 110 to communicate with other devices such as client devices 140 and remote device 160, over one or more networks such as a wide area network (WAN). Hardware platform 130 may also use an external storage device (not shown) such as a network-attached storage (NAS) device.

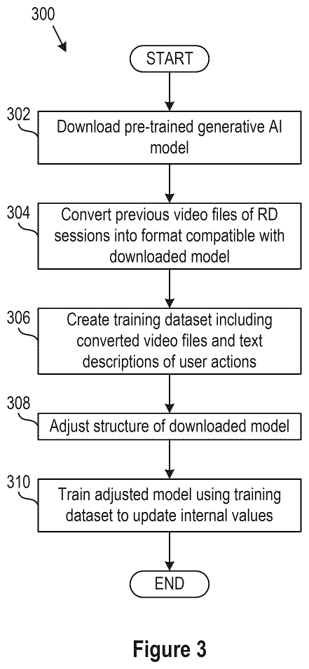

Hardware platform 130 supports software 120, which includes a session manager 122, a session auditor 124, a generative AI model 126, and a session recording monitor 128. Session manager 122 authorizes the creations of RD sessions between client devices 140 and remote device 160 and responds to detections of prohibited and suspicious behaviors. Session auditor 124 invokes generative AI model 126 to acquire text descriptions of user behaviors and parses the text descriptions for keywords or phrases indicative of prohibited and suspicious behaviors. Generative AI model 126 may be, e.g., an open source generative AI model such as Generative Pre-trained Transformer 4 (GPT-4®) from OpenAI, which may be “fine-tuned” to accurately create text descriptions of user behaviors in RD sessions, as discussed further below in conjunction with FIG. 3. Session recording monitor 128 communicates with remote device 160 to acquire recordings of RD sessions for auditing.

Each of client devices 140 is a computer such as a personal computer of a user, e.g., a personal desktop computer, laptop, tablet computer, or smartphone of an employee of the organization. Each of client devices 140 includes a hardware platform (not shown) including, e.g., memory, one or more CPUs configured to execute instructions that perform one or more operations described herein, which may be stored in the memory, and one or more NICs for communicating with other devices such as connection device 110 and with remote device 160. In each of client devices 140, the hardware platform supports software including RD client software 150, which is programmed to access RD environments via RD sessions. For example, RD client software 150 may be an instance of VMware Horizon® Client, available from VMware LLC.

Remote device 160 is a computer, such as a server in a private data center controlled by the organization. Remote device 160 includes a hardware platform (not shown) including, e.g., memory, one or more CPUs configured to execute instructions that perform one or more operations described herein, which may be stored in the memory, and one or more NICs for communicating with other devices such as connection device 110 and with client devices 140. In remote device 160, the hardware platform supports software including RD agent software 170 and RD environments 180. RD agent software 170 is programmed to host RD environments 180, including communicating with RD client 150 in each of client devices 140 to acquire user inputs from client devices 140 and to transmit images of interfaces of RD environments 180 such as GUIs to client devices 140. For example, RD agent software 170 may be an instance of VMware Horizon® Agent, available from VMware LLC.

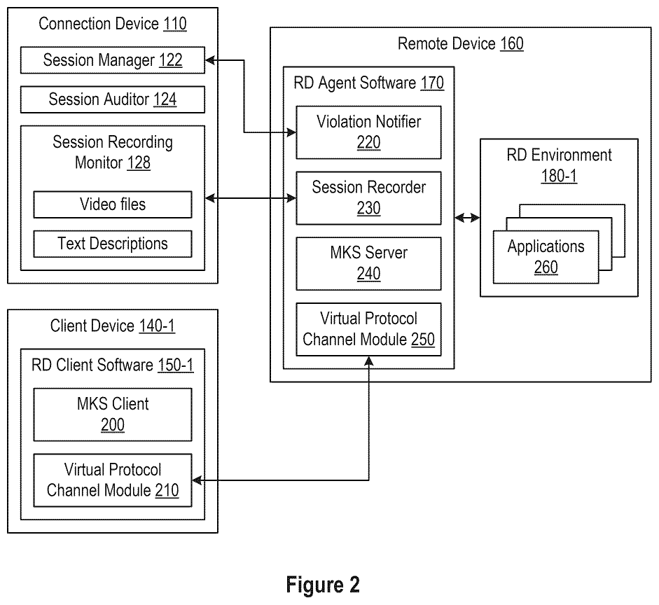

FIG. 2 is a block diagram of an RD session of computer system 100. In the RD session, RD client software 150-1 of a client device 140-1 accesses an RD environment 180-1 of remote device 160. RD environment 180-1 includes applications 260 accessed remotely by a user of client device 140-1 via the RD session. To enable such access, RD client software 150-1 includes a mouse, keyboard, screen (MKS) client 200 and a virtual protocol channel module 210. RD agent software 170 includes a violation notifier 220, a session recorder 230, an MKS server 240, and a virtual protocol channel module 250.

Virtual protocol channel modules 210 and 250 communicate with each other to establish the communication of the RD session. For example, such communication may utilize user datagram protocol (UDP) for communication of information in which some data loss is acceptable. For example, it may be acceptable to have some data loss of images of GUIs transmitted from remote device 160 to client device 140-1. Such communication may also utilize transmission control protocol (TCP) for communication of other information without data loss.

When the user of client device 140-1 performs actions in the RD session such as typing on a keyboard or moving or clicking a computer mouse, MKS client 200 detects those actions and transmits instructions describing those actions to MKS server 240 via virtual protocol channel modules 210 and 250. RD environment 180-1 is then updated according to the instructed actions, e.g., a command being performed by one of applications 260 such as accessing a website. MKS server 240 periodically generates an image of an interface of RD environment 180-1 such as a GUI and transmits the image to MKS client 200 via virtual protocol channel modules 210 and 250. Client device 140-1 then displays the image, e.g., on a screen of client device 140-1 or on a computer monitor (not shown) connected to client device 140-1.

Session recorder 230 monitors RD environment 180-1 to record user actions therein. For example, session recorder 230 may continuously record RD environment 180-1 during the RD session and create discrete recordings thereof for auditing. For example, each recording may be a video file of a predetermined length such as five minutes. At the end of each interval of the predetermined length, session recorder 230 may transmit, to session recording monitor 128 of connection device 110, a new video file of the user behavior since the previous recording, e.g., over the previous five minutes.

It should be noted that the length of time to capture in each video file may be selected by an administrator of computer system 100 based on a variety of factors. For example, the length of time may be decreased (e.g., to thirty seconds), to increase the frequency at which session recorder 230 transmits videos to session recording monitor 128. This potentially increases the speed at which malicious behaviors are detected at connection device 110, which increases how quickly connection device 110 responds, e.g., by terminating the RD session. As another example, the length of time may be increased (e.g., to thirty minutes), to decrease resource consumption by the recording and auditing, e.g., to decrease processing consumption at remote device 160 and connection device 110 and to decrease bandwidth consumption over the one or more networks therebetween.

Session recording monitor 128 at least temporarily stores video files received from session recorder 230, e.g., in storage 136 or external storage. Additionally, after auditor 124 invokes generative AI model 126 to acquire text descriptions of video files, session recording monitor 128 stores such text descriptions, e.g., in storage 136 or external storage. If there is no prohibited or suspicious behavior detected in one of the video files, session recording monitor 128 deletes the video file to save space. Sometimes, e.g., when suspicious behaviors are detected from a recorded video, session manager 122 transmits a warning message to violation notifier 220, and violation notifier 220 displays the warning message in the interface of RD environment 180-1. The next time MKS server 240 generates an image of the interface and transmits the image to MKS client 200, client device 140-1 displays the image to the user including the warning message.

FIG. 3 is a flow diagram of a method 300 performed by connection device 110 to train generative AI model 126, according to some embodiments. At step 302, connection device 110 downloads a pre-trained generative AI model such as GPT-4.® The downloaded pre-trained generative AI model may have already been trained to output text descriptions of user behaviors based on video files of RD sessions. However, to improve the pre-trained AI model's ability to accurately output such text descriptions, the pre-trained AI model may be fine-tuned in steps 304-310.

At step 304, connection device 110 converts several previous video files of RD sessions into a format that is compatible with the downloaded model. Examples of video files include MP4 files, QuickTime Movie (MOV) files, and Windows Media Video (WMV) files, visually capturing RD sessions. The format of the video files, e.g., MP4, may be incompatible with the downloaded model, so connection device 110 converts the video files to data of a different format that is compatible with the downloaded model, e.g., to JavaScript Object Notation (JSON) format. The data of the different format, which still visually captures the RD sessions, is referred to herein as “video data.”

At step 306, connection device 110 creates a training dataset including the video data of the converted video files. Additionally, for example, connection device 110 includes, in the training dataset, text descriptions of the user behaviors for supervised training. The text descriptions in the training dataset are expected outputs of the model and may be, e.g., created by an administrator of computer system 100 based on manual reviews of the previous videos. At step 308, connection device 110 adjusts the structure of the downloaded model. For example, connection device 110 may increase the number of internal layers of nodes in the downloaded model to increase the accuracy of text outputs. On the other hand, for example, connection device 110 may decrease the number of such internal layers to increase the speed at which the downloaded model outputs text descriptions of user behaviors based on input video data.

At step 310, connection device 110 trains the adjusted model using the training dataset to update internal values of the downloaded model such as weights at nodes thereof. For example, for supervised training, as video data of the training dataset is input into the adjusted model, the actual outputs of the adjusted model are compared to corresponding text descriptions from the training dataset (expected outputs). Errors between the actual outputs and the expected outputs are backpropagated through nodes of the model to update weights at the nodes based on, e.g., the magnitudes of the errors. After step 310, method 300 ends.

It should be noted that method 300 is just one example of preparing generative AI model 126. For example, a downloaded generative AI model may be used to monitor user behaviors, without the fine-tuning of steps 304-310. As another example, step 308 may be omitted to maintain the same structure as that of the downloaded model. As another example, a different method of training may be used for fine-tuning the generative AI model such as a form of unsupervised training that does not require the use of expected outputs.

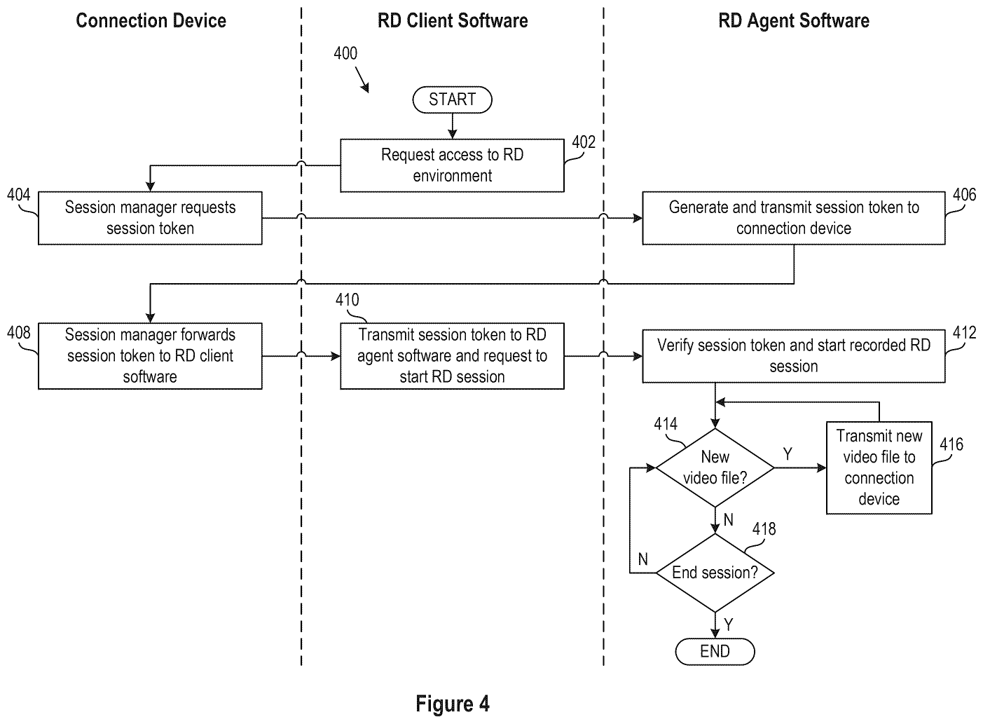

FIG. 4 is a flow diagram of a method 400 performed by connection device 110, one of client devices 140, and remote device 160 to start and monitor an RD session, according to some embodiments. Method 400 will be discussed with respect to client device 140-1 accessing RD environment 180-1 via an RD session. However, method 400 may be performed by any of client devices 140 accessing any of RD environments 180. Steps discussed with respect to client device 140-1 may be performed by others of client devices 140, and steps discussed with respect to RD environment 180-1 may be performed with respect to others of RD environments 180.

At step 402, RD client software 150-1 transmits a request to connection device 110 to access RD environment 180-1. For example, RD client software 150-1 may access an interface of connection device 110 that lists one or more RD environments that client device 110 has permission to access, including RD environment 180-1. Upon the user of client device 140 selecting RD environment 180-1 from the list, e.g., by clicking on an icon corresponding thereto, RD client software 150-1 transmits the request. At step 404, session manager 122 of connection device 110 transmits a request to RD agent software 170 for a session token.

At step 406, RD agent software 170 generates the session token and transmits the session token to connection device 110. For example, the session token may be a randomly or pseudo-randomly generated sequence of characters. At step 408, session manager 122 forwards the session token to RD client software 150-1. At step 410, RD client software 150-1 transmits the session token to RD agent software 170 and a request to start an RD session to access RD environment 180-1.

At step 412, RD agent software 170 verifies the session token as being the same as that transmitted at step 406. Upon such verification, RD agent software 170 starts a recorded RD session with RD client software 150-1. The user of client device 140-1 then begins remotely performing actions in RD environment 180-1 via the recorded RD session, e.g., using applications 260, as session recorder 230 records such actions. It should be noted that the communication and verification of the session token in steps 404-412 are just one example of securely starting an RD session, and embodiments are not limited thereto.

At step 414, session recorder 230 determines whether to transmit a new video file to session recording monitor 128. For example, if session recorder 230 transmits a new video file at the end of predetermined time intervals, session recorder 230 determines whether the end of one of such intervals has been reached. If session recorder 230 determines to transmit a new video file, e.g., because the end of an interval has been reached, method 400 moves to step 416. At step 416, session recorder 230 transmits a video file to session recording monitor 128 for auditing, and method 400 returns to step 414. For example, if session recorder 230 transmits a video file every five minutes, the transmitted video file visually captures the last five minutes of user behavior.

Returning to step 414, if session recorder 230 determines not to transmit a new video file, e.g., the end of a predetermined interval has not been reached, method 400 moves to step 418. At step 418, RD agent software 170 determines whether to end the RD session. For example, the user of client device 140-1 may have instructed to logout of the RD environment 180-1 (and logout of the RD session). If RD agent software 170 determines not to end the RD session, method 400 returns to step 414. On the other hand, if RD agent software 170 determines to end the RD session, e.g., because the user instructed to logout, method 400 ends.

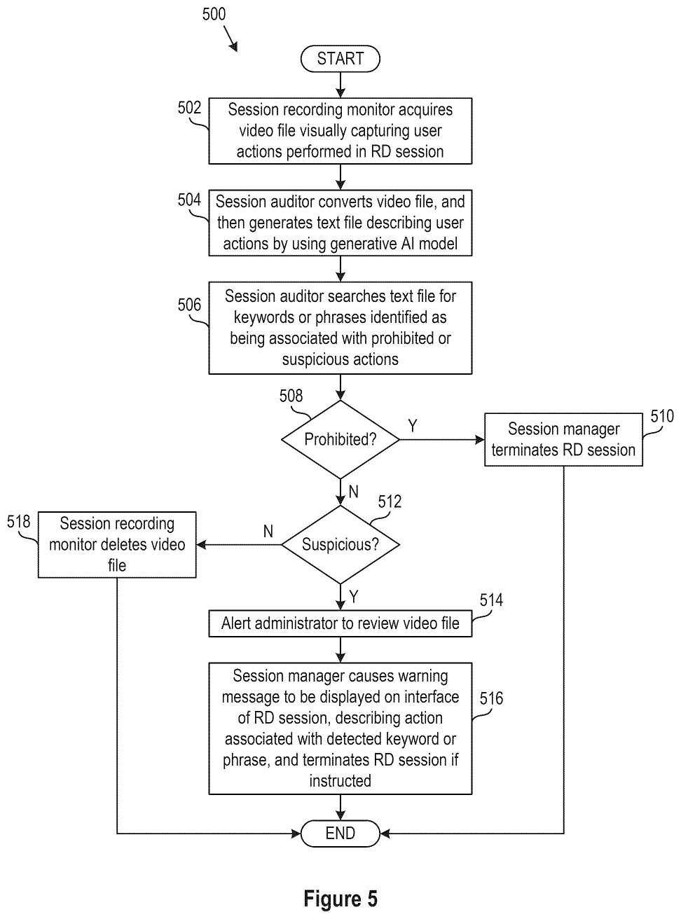

FIG. 5 is a flow diagram of a method 500 performed by connection device 110 to audit recordings of RD sessions, according to some embodiments. Method 500 will be discussed with respect to RD environment 180-1. However, method 500 may be performed with respect to any of RD environments 180. Accordingly, steps discussed with respect to RD environment 180-1 may be performed with respect to others of RD environments 180.

At step 502, session recording monitor 128 acquires a video file visually capturing user actions performed in RD environment 180-1. Session recording monitor 128 stores the video file, e.g., in memory 134, in storage 136, or in an external storage device. At step 504, session auditor 124 converts the video file to a format compatible with generative AI model 126, e.g., JSON format, and generates a text file describing the user actions in words by using generative AI model 126. For example, session auditor 124 may input the video data of the converted video file into generative AI model 126 along with a prompt such as “What are the main activities that take place in the video?” In response to the video data and prompt, the generative AI model 126 outputs the text file. Session recording monitor 128 stores the generated text file, e.g., in memory 134, in storage 136, or in an external storage device.

At step 506, session auditor 124 parses (searches) the text file for keywords or phrases identified as being associated with prohibited or suspicious actions. For example, an administrator of computer system 100 may have identified such keywords and phrases and labeled each as being either prohibited or suspicious. For example, if there is a website that is prohibited from being accessed in RD environment 180-1, a keyword may be a uniform resource locator (URL) of the website. As another example, if there is an application that is prohibited from being downloaded or used, a keyword may be a name of the prohibited application. As another example, it may be considered suspicious for a user to download an attachment to an email, so a phrase to search for may be “downloaded attachment” or a similar phrase.

At step 508, session auditor 124 determines whether any prohibited behavior was detected in the text file. If session auditor 124 found a keyword or phrase in the text file corresponding to prohibited behavior, method 500 moves to step 510. At step 510, session manager 122 terminates the RD session by transmitting a request to RD agent software 170 to terminate the RD session. RD agent software 170 then terminates the RD session, ending the user's access to RD environment 180-1 via virtual protocol channel module 250. After step 510, method 500 ends.

Returning to step 508, if session auditor 124 did not find a keyword or phrase corresponding to prohibited behavior, method 500 moves to step 512. At step 512, session auditor 124 determines whether any suspicious behavior was detected in the text file. If session auditor 124 found a keyword or phrase in the text file corresponding to suspicious behavior, method 500 moves to step 514. At step 514, connection device 110 alerts an administrator of computer system 100 to review the video file. For example, session recording monitor 128 may move the video file to a particular directory, e.g., of storage 136 or of an external storage device, corresponding to suspicious video files, such placement in the directory alerting the administrator.

At step 516, session manager 122 responds to the suspicious behavior. Specifically, session manager 122 causes a warning message to be displayed on the interface of RD environment 180-1. Session manager 122 does so by transmitting the warning message to violation notifier 220, which adds the warning message to the interface. The warning message describes the action associated with the detected keyword or phrase, i.e., the action that was determined to be suspicious. Additionally, for example, if the administrator reviews the video file and instructs session manager 122 to terminate the RD session, session manager 122 terminates the RD session in the manner discussed above with respect to step 510. The administrator may also, for example, directly instruct RD agent software 170 to terminate the RD session by directly accessing an interface of RD agent software 170. After step 516, method 500 ends.

Returning to step 512, if session auditor 124 did not find a keyword or phrase in the text file corresponding to suspicious behavior, method 500 moves to step 518. At step 518, session recording monitor 128 deletes the video file, e.g., from memory 134, from storage 136, or from an external storage device, to save memory or storage space of connection device 110. However, it should be noted that session recording monitor 128 may continue storing the generated text file, which describes the user actions captured by the video, and which takes up less storage space than the video file. After step 518, method 500 ends.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc., and combinations thereof, which may communicate across one or more networks.

One or more embodiments of the present invention may be implemented as one or more computer programs or as one or more computer program modules embodied in computer-readable media. The term computer-readable medium refers to any data storage device that can store data that can thereafter be input into a computer system. Computer-readable media may be based on any existing or subsequently developed technology that embodies computer programs in a manner that enables a computer to read the programs. Examples of computer-readable media are magnetic drives, SSDs, network-attached storage (NAS) systems, read-only memory (ROM), RAM, compact disks (CDs), digital versatile disks (DVDs), magnetic tapes, and other optical and non-optical data storage devices. A computer-readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest OS that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of auditing user actions performed in remote desktop (RD) sessions, the method comprising:
acquiring a first video file that visually captures a plurality of first user actions that were performed in a first RD session by a remote device hosting the first RD session in response to instructions from a client device of the first RD session;
generating a first text file describing the first user actions from the first video file, by using a generative artificial intelligence (AI) model that has been trained to generate text descriptions of user actions from video data capturing user actions in RD sessions;
searching the first text file for keywords or phrases that have been identified as being associated with prohibited or suspicious actions; and
in response to detecting one of the keywords or phrases in the first text file, terminating the first RD session.

2. The method of claim 1, wherein the first video file is received at a connection device separate from the remote device, that monitors RD sessions hosted by the remote device, and wherein terminating the first RD session comprises transmitting a request from the connection device to the remote device to terminate the first RD session.

3. The method of claim 1, wherein the first user actions include one of: accessing a prohibited website and installing or using a prohibited application, and wherein the keywords or phrases include one of: a name or uniform resource locator (URL) of the prohibited website and a name of the prohibited application.

4. The method of claim 1, further comprising:
training the generative AI model with a plurality of video files each visually capturing user actions performed in RD sessions and with a plurality of text descriptions corresponding to the plurality of video files.

5. The method of claim 1, further comprising:
acquiring a second video file that visually captures a plurality of second user actions that were performed in a second RD session;
generating a second text file describing the second user actions from the second video file, by using the generative AI model;
detecting one of the keywords or phrases in the second text file; and
in response to detecting the one of the keywords or phrases in the second text file, causing a warning message to be displayed in a graphical user interface (GUI) of the second RD session, wherein the warning message describes one of the plurality of second actions associated with the detected one of the keywords or phrases in the second text file.

6. The method of claim 1, further comprising:
acquiring a second video file that visually captures a plurality of second user actions that were performed in a second RD session;
generating a second text file describing the second user actions from the second video file, by using the generative AI model;
detecting one of the keywords or phrases in the second text file; and
in response to detecting the one of the keywords or phrases in the second text file, alerting an administrator of the second RD session to review the second video file.

7. The method of claim 1, further comprising:
acquiring a second video file that visually captures a plurality of second user actions that were performed in a second RD session;
generating a second text file describing the second user actions from the second video file, by using the generative AI model;
searching the second text file for the keywords or phrases; and
in response to determining that none of the keywords or phrases are in the second text file, deleting the second video file from memory or storage of a computer that acquired the second video file.

8. A non-transitory computer-readable medium comprising instructions that are executable in a computer system, wherein the instructions when executed cause the computer system to carry out a method of auditing user actions performed in remote desktop (RD) sessions, wherein the method comprises:
acquiring a first video file that visually captures a plurality of first user actions that were performed in a first RD session by a remote device hosting the first RD session in response to instructions from a client device of the first RD session;
generating a first text file describing the first user actions from the first video file, by using a generative artificial intelligence (AI) model that has been trained to generate text descriptions of user actions from video data capturing user actions in RD sessions;
searching the first text file for keywords or phrases that have been identified as being associated with prohibited or suspicious actions; and
in response to detecting one of the keywords or phrases in the first text file, terminating the first RD session.

9. The non-transitory computer-readable medium of claim 8, wherein the first video file is received at a connection device separate from the remote device, that monitors RD sessions hosted by the remote device, and wherein terminating the first RD session comprises transmitting a request from the connection device to the remote device to terminate the first RD session.

10. The non-transitory computer-readable medium of claim 8, wherein the first user actions include one of: accessing a prohibited website and installing or using a prohibited application, and wherein the keywords or phrases include one of: a name or uniform resource locator (URL) of the prohibited website and a name of the prohibited application.

11. The non-transitory computer-readable medium of claim 8, wherein the method further comprises:
training the generative AI model with a plurality of video files each visually capturing user actions performed in RD sessions and with a plurality of text descriptions corresponding to the plurality of video files.

12. The non-transitory computer-readable medium of claim 8, wherein the method further comprises:
acquiring a second video file that visually captures a plurality of second user actions that were performed in a second RD session;
generating a second text file describing the second user actions from the second video file, by using the generative AI model;
detecting one of the keywords or phrases in the second text file; and
in response to detecting the one of the keywords or phrases in the second text file, causing a warning message to be displayed in a graphical user interface (GUI) of the second RD session, wherein the warning message describes one of the plurality of second actions associated with the detected one of the keywords or phrases in the second text file.

13. The non-transitory computer-readable medium of claim 8, wherein the method further comprises:
acquiring a second video file that visually captures a plurality of second user actions that were performed in a second RD session;
generating a second text file describing the second user actions from the second video file, by using the generative AI model;
detecting one of the keywords or phrases in the second text file; and
in response to detecting the one of the keywords or phrases in the second text file, alerting an administrator of the second RD session to review the second video file.

14. The non-transitory computer-readable medium of claim 8, wherein the method further comprises:
acquiring a second video file that visually captures a plurality of second user actions that were performed in a second RD session;
generating a second text file describing the second user actions from the second video file, by using the generative AI model;
searching the second text file for the keywords or phrases; and
in response to determining that none of the keywords or phrases are in the second text file, deleting the second video file from memory or storage of a computer that acquired the second video file.

15. A computer including a processor and memory, wherein the computer is configured to use the processor to execute instructions from the memory to:
acquire a first video file that visually captures a plurality of first user actions that were performed in a first RD session by a remote device hosting the first RD session in response to instructions from a client device of the first RD session;
generate a first text file describing the first user actions from the first video file, by using a generative artificial intelligence (AI) model that has been trained to generate text descriptions of user actions from video data capturing user actions in RD sessions;
search the first text file for keywords or phrases that have been identified as being associated with prohibited or suspicious actions; and
in response to detecting one of the keywords or phrases in the first text file, terminate the first RD session.

16. The computer of claim 15, wherein terminating the first RD session comprises transmitting a request to the remote device to terminate the first RD session.

17. The computer of claim 15, further configured to use the processor to execute the instructions from the memory to:
train the generative AI model with a plurality of video files each visually capturing user actions performed in RD sessions and with a plurality of text descriptions corresponding to the plurality of video files.

18. The computer of claim 15, further configured to use the processor to execute the instructions from the memory to:
acquire a second video file that visually captures a plurality of second user actions that were performed in a second RD session;
generate a second text file describing the second user actions from the second video file, by using the generative AI model;
detect one of the keywords or phrases in the second text file; and
in response to detecting the one of the keywords or phrases in the second text file, cause a warning message to be displayed in a graphical user interface (GUI) of the second RD session, wherein the warning message describes one of the plurality of second actions associated with the detected one of the keywords or phrases in the second text file.

19. The computer of claim 15, further configured to use the processor to execute the instructions from the memory to:
acquire a second video file that visually captures a plurality of second user actions that were performed in a second RD session;
generate a second text file describing the second user actions from the second video file, by using the generative AI model;
detect one of the keywords or phrases in the second text file; and
in response to detecting the one of the keywords or phrases in the second text file, alert an administrator of the second RD session to review the second video file.

20. The computer of claim 15, further configured to use the processor to execute the instructions from the memory to:
acquire a second video file that visually captures a plurality of second user actions that were performed in a second RD session;
generate a second text file describing the second user actions from the second video file, by using the generative AI model;
search the second text file for the keywords or phrases; and
in response to determining that none of the keywords or phrases are in the second text file, delete the second video file from memory or storage of the computer.
